(19) United States
(12) Patent Application Publication
(10) Pub. No.: US 2025/0363559 A1
(43) Pub. Date: Nov. 27, 2025

(54) BOT TO BOT FINANCING

(71) Applicant: Wells Fargo Bank, N.A., San Francisco, CA (US)

(72) Inventors: James D. Cahill, Belmont, MA (US); Nathan B. Coles, El Cerrito, CA (US); Luke N. deNatale, Grapevine, TX (US); Sean P. Hanrahan, Santa Monica, CA (US); Jack James Malpas-Coker, Dallas, TX (US); Tyus Pettis, San Francisco, CA (US)

(21) Appl. No.: 18/670,136

(22) Filed: May 21, 2024

(51) Int. Cl. G06Q 40/06; G06Q 20/38

(52) U.S. Cl. CPC G06Q 40/06; G06Q 20/3821

(57) ABSTRACT

Systems and techniques are provided to facilitate autonomous financing decision-making by deploying an autonomous decision bot within a client system. These systems and techniques enable the autonomous decision bot to access financial data relevant to a financing decision directly from the client system. The autonomous decision bot analyzes the accessed financial data according to financing rules established by a financial institution associated with the client system to determine a financing decision without transmitting the accessed financial data to the financial institution. The system facilitates the communication of the financing decision to the financial institution and, upon receipt of a confirmation from the financial institution, outputs an indication of the financing decision to the client system.

### TECHNICAL FIELD

The present disclosure generally relates to the field of automated data control and data privacy, specifically to techniques for enhancing privacy and decision-making efficiency through the use of an autonomous bot deployed within a client system.

### BACKGROUND

The domain of financing decisions, particularly in the context of digital and automated systems, has seen considerable evolution with the implementation of innovative technologies designed to streamline processes and improve the accuracy of financing outcomes. However, traditional financing decision processes face inherent limitations, such as reliance on manual review of extensive documentation, vulnerability to human error, delays in decision-making, and the challenge of maintaining data security. Current techniques suffer from errors in accuracy, data fidelity, and transaction speed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 illustrates a system for using an autonomous bot, according to various examples.

FIGS. 2A-2B illustrate an example client system for interacting with an autonomous bot, according to various examples.

FIG. 3 illustrates an example secure execution environment, such as a trusted execution environment (TEE), or a secure system (e.g., one not connected to other client systems or data), according to various examples.

FIG. 4 illustrates a machine learning engine for training and execution related to ensuring data privacy using an autonomous decision bot, according to various examples.

FIG. 5 illustrates a flowchart showing a technique for ensuring data privacy during an autonomous bot decision, according to various examples.

FIG. 6 illustrates generally an example of a block diagram of a machine upon which any one or more of the techniques discussed herein may perform, according to various examples.

### DETAILED DESCRIPTION

The systems and techniques described herein solve various technical problems such as limitations associated with protecting data privacy during a financing decision. These processes often require manual intervention, extensive documentation review, transfer of data or files to a financial institution, or prolonged decision times. The systems and techniques described herein address privacy concerns related to sharing sensitive financial data with external parties, such as banks, and mitigates the risk of data breaches. The privacy concerns are mitigated while also providing security to a decision-making autonomous bot such that the autonomous bot may perform a secure technical analysis of client data within a client system but without interference from the client system or a client.

An example technical challenge related to automating financing decisions is ensuring the accuracy and reliability of these decisions while maintaining the confidentiality of sensitive client data. This example technical challenge includes issues in creating a secure and efficient method for a financial institution to issue a financing decision without direct access to detailed client data.

To address these challenges, the systems and techniques described herein include deploying an autonomous decision bot within a client system. The autonomous decision bot may securely access, analyze, and extract financial data relevant to a financing decision based on criteria set by a financial institution. By automating the process and limiting access to within the client system for client financial data, the autonomous decision bot reduces the time required for decision-making, minimizes the risk of data breaches, and ensures the confidentiality of customer information.

In an example, a customer connects the autonomous decision bot to an Enterprise Resource Planning (ERP) system. The connection may be initiated by the customer granting the autonomous decision bot necessary permissions to access the ERP system through a secure authentication process. Once connected, the autonomous decision bot retrieves client data relevant for making a financing decision. In some examples, autonomous decision bot may extract invoices to obtain insights into the customer's revenue streams and outstanding receivables. The autonomous decision bot may access inventory data, including quantities, values, or turnover rates, to assess the operational efficiency of the customer's business. In some examples, the autonomous decision bot may pull client data such as payroll records, bank statements, or tax returns from the ERP system. The autonomous decision bot may analyze the client data based on financing rules set by the financial institution associated with the autonomous decision bot. These rules may include factors such as debt-to-income ratios, payment history, or current financial obligations. The financing decision may be securely transmitted to the financial institution by the autonomous decision bot. In an example, the autonomous decision bot transmits validation information to the client system confirming the identity of the autonomous decision bot prior to accessing the client data (e.g., the autonomous decision bot is not executed until the client system confirms the identity).

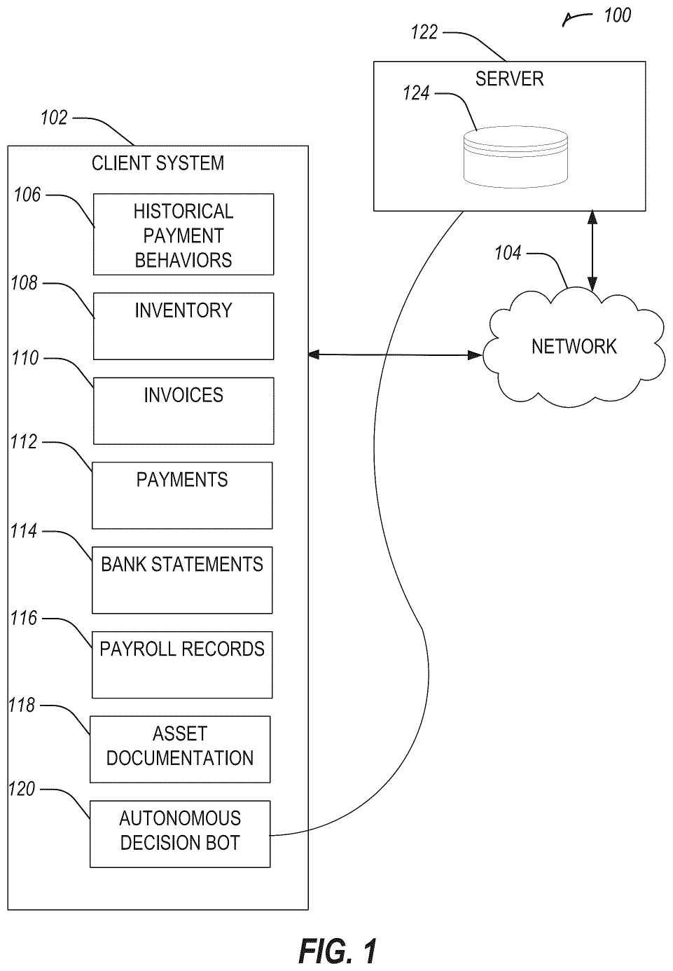

FIG. 1 illustrates a system 100 for deploying an autonomous decision bot within a client system, according to various examples. The system 100 includes a client system 102. The autonomous decision bot 120 may be sent to the client system 102 for executing in the client system 102, allowing the autonomous decision bot 120 to access various types of client data, such as historical payment behaviors 106, inventory 108, invoices 110, payments 112, bank statements 114, payroll records 116, and asset documentation 118.

The system 100 may include a server 122 or a database 124, for example at a financial institution. The server 122 or database 124 may be a single device, may include multiple devices, may be located in different or same locations, etc. The client system 102 may communicate with the server 122 via a network 104 (e.g., the internet). The server 122 or the database 124 may store authentication information for authenticating a decision by the autonomous decision bot 120. The autonomous decision bot 120 may be granted permission to access sensitive data from the client system 102 (e.g., by a client owner or operator of the client system 102). The autonomous decision bot 120 may be sent to the client system 102 in response to a request for a financial decision by the financial institution operating the server 122. The request may include a request for a loan, line of credit, change in interest rate, mortgage, checking account, savings account, other type of account, another banking service, or the like. The financial decision may include approving or denying the request. In some examples, the financial decision may include sending a request for more information before approving or denying the request. The autonomous decision bot 120 may receive the financial decision or the financial decision may be sent directly to the client system 102.

The server 122 may implement a secure authentication technique, including verifying authentication information (e.g., comparing authentication data received from the client system 102 via the network 104 to stored authentication data from the database 124). During the authentication process, the stored authentication data, which may be located in long-term memory, is retrieved from the database 124. Through the network 104, the client system 102 may securely transmit authentication data to the server 122 and receive an authentication response.

The database 124 may store a set of rules for guiding the autonomous decision bot 120 in determining whether to approve a request. In an example, the client system 102 sends a request for a loan or other financial product or service to the server 122 via the network 104. The server retrieves a set of rules applicable to the request and sends the autonomous decision bot 120 to the client system. The autonomous decision bot 120 may be configured with the set of rules at the server 122 or at the client system 102. In other examples, the autonomous decision bot 120 may be selected based on the rules (e.g., a rule or a set of rules may correspond to a particular autonomous decision bot of a plurality of autonomous decision bots). The autonomous decision bot 120 may process the various data stored at the client system 102 according to the set of rules to evaluate whether to approve or deny the request. For example, the set of rules may include a range or threshold for income, revenue, debt, liabilities, etc., a classification based on business type, a range or threshold of a number, such as a number of employees, a number of owners, a number of silent partners, etc., an asset checklist, or any other consideration typically useful for evaluating the request. The autonomous decision bot 120 may determine whether to approve or deny the request. The determination may be output to the client system 102 automatically. Instead of or in addition to outputting to the client system 102, the determination may be output to the server 122 automatically. The server 122 may output the determination for display, such as for confirmation by an employee of the financial institution. When confirmed, the determination may be sent to the client system 102 directly or to the autonomous decision bot 120 for outputting to the client system 102.

In some examples, the autonomous decision bot 120 may use machine learning in making the determination of whether to approve or deny the request from the client. For example, the autonomous decision bot 120 may include a model trained using machine learning to summarize, extract data, or otherwise interpret or process a document of the client system 102 (e.g., bank statements 114, payroll records 116, asset documentation 118, etc.). The autonomous decision bot 120 may include a model (the same model or a different model) trained using machine learning to synthesize information, such as a trajectory of revenue (e.g., from the payments 112, the invoices 110, the inventory 108, or the like). The autonomous decision bot 120 may include a model (the same model or a different model) trained using machine learning to make the determination. For example, a normalized set of data and the set of rules may be input to the model to receive the determination as an output. In some examples, a deterministic non-machine learning technique may be used to ensure consistency of determinations by the autonomous decision bot 120. In other examples, machine learning may be used (with or without the non-machine learning technique) to provide more flexibility. Either approach allows for an autonomous determination by the autonomous decision bot 120 without data being output from the client system 102.

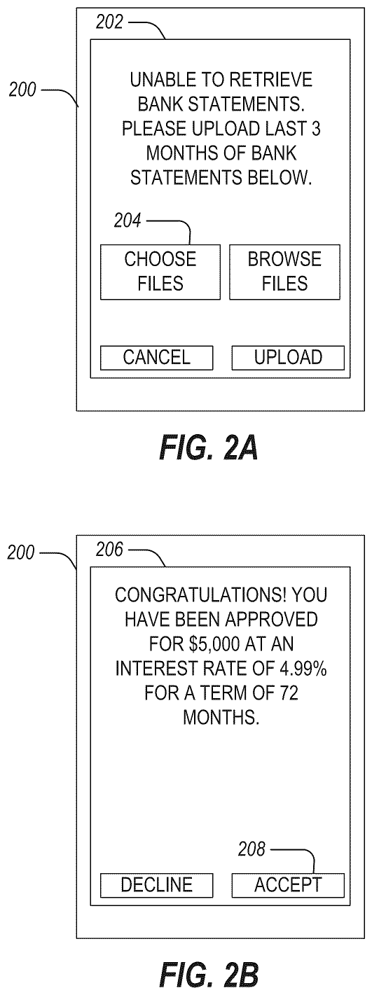

FIGS. 2A-2B illustrate an example client system for displaying notifications and requests from an autonomous decision bot, according to various examples.

FIG. 2A illustrates a first example configuration of a display 200. The display 200 includes a user interface 202, which facilitates interaction between a customer and the autonomous decision bot. In some examples, where the autonomous decision bot is unable to retrieve certain information or make a determination based on available information, the user interface 202 may display an option to upload one or more additional files (e.g., proof of income, asset information, tax returns, or the like) using selectable indication 204.

FIG. 2B illustrates a second example configuration of the display 200. The display 200 includes a user interface 206 that presents notifies an indication of a successful loan approval based on an analysis by the autonomous decision bot. In the user interface 206, a notification of the loan approval is presented along with a selectable indication 208 to accept the loan offer. The user interface 206 may be used to decline the offer. In some examples, the loan approval presented in the user interface 206 may detail the loan amount approved, the interest rate offered, repayment terms, criteria used in the determination of the offer, or the like.

In other examples, the display 200 may present a scenario where the financial request is denied by the autonomous decision bot. In these examples, the display 200 may present a notification of the denial or include a reason for the decision, such as insufficient credit history or a lack of verifiable income. In some examples, the display 200 may offer a suggestion for a next step or include a predetermined message by the financial institution deploying the autonomous decision bot.

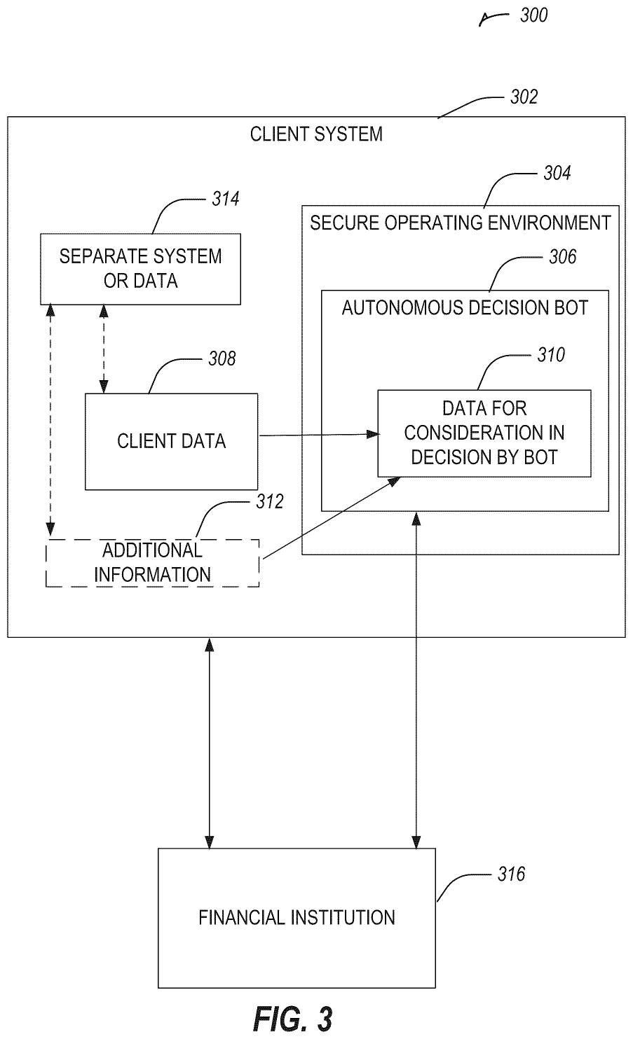

FIG. 3 illustrates an example secure operating environment 304, such as a trusted execution environment (TEE), a secure execution system (e.g., one not connected to other client systems or data), or the like, according to various examples. The secure operating environment 304 may be part of a client system 302, which may include various components, such as a processor, data storage, etc. In some examples, the secure operating environment 304 is located at a single device of the client system 302, while in other examples, the secure operating environment 304 is spread out over two or more devices of the client system 302.

The secure operating environment 304 may be used for execution of an autonomous decision bot 306 (e.g., as described herein). The autonomous decision bot 306 may be sent by an enterprise device, such as at financial institution 316 to the client system 302. The client system 302 may send the autonomous decision bot 306 to the secure operating environment 304 for execution. The autonomous decision bot 306 may receive (e.g., in response to a request by the autonomous decision bot 306 or on initiation by the client system 302) client data 308. The client data 308 may be stored in its operating location (e.g., where the client system 302 typically access the data from, such as a database, memory, etc.) or may be stored in a particular location for access by the autonomous decision bot 306. The particular location may be a location that is itself a secure operating environment or secure storage (e.g., an environment or storage that is read only, that includes a firewall between the client data 308 and other elements of the client system 302, or the like). In some examples, the particular location may be within the secure operating environment 304 (not shown). In these examples, the client data 308 may be loaded before operation of the autonomous decision bot 306, for example to prevent the autonomous decision bot 306 from being active during a data transfer from the client system 302 to the secure operating environment 304. In these examples, after loading the client data 308, a data connection may be severed before the autonomous decision bot 306 is activated.

The autonomous decision bot 306 may use a portion of the secure operating environment 304 for its own secure storage of data 310 for consideration in a decision by the autonomous decision bot 306. For example, the autonomous decision bot 306 may store data as read only in the secure operating environment 304 to prevent a change during a decision or to prevent a change after a decision. This way, the record for both the client system 302 and the financial institution 316 may be preserved in a verifiable unaltered state.

In some examples, the client data 308 may be insufficient for making a decision by the autonomous decision bot 306. In these examples, the autonomous decision bot 306 may request additional data, which may be retrieved from additional information 312. The additional information 312 may be retrieved from a separate system or data 314 of the client system 302. The separate system or data 314 may include the additional information 312 not in the client data 308 (e.g., in examples where the client data 308 is limited to what the client system 302, optionally via the separate system or data 314, initially supplied to the autonomous decision bot 306). The client data 308, the additional information 312, or a combination thereof may not represent all data available at the client system 302 (e.g., some information may be kept secret from the autonomous decision bot 306, even after requesting additional information). This may allow the client system 302 to protect data that is not relevant to a decision by the autonomous decision bot 306, such as personal medical information, non-business data (which may occasionally be accidentally intermingled in client system 302 in examples where the client system 302 corresponds to a small business, for example), etc. The autonomous decision bot 306 may store the additional information 312 in the data 310. Storage of information in the data 310 may be helpful to capture data at a particular moment in time, which may also be useful to the client system 302 to not need to keep data in a particular format (e.g., the client system 302 can continue to update business records during day-to-day operations without affecting the data 310 available to the autonomous decision bot 306). In some examples, the secure operating environment 304 may be located on a separate device to the separate system or data 314.

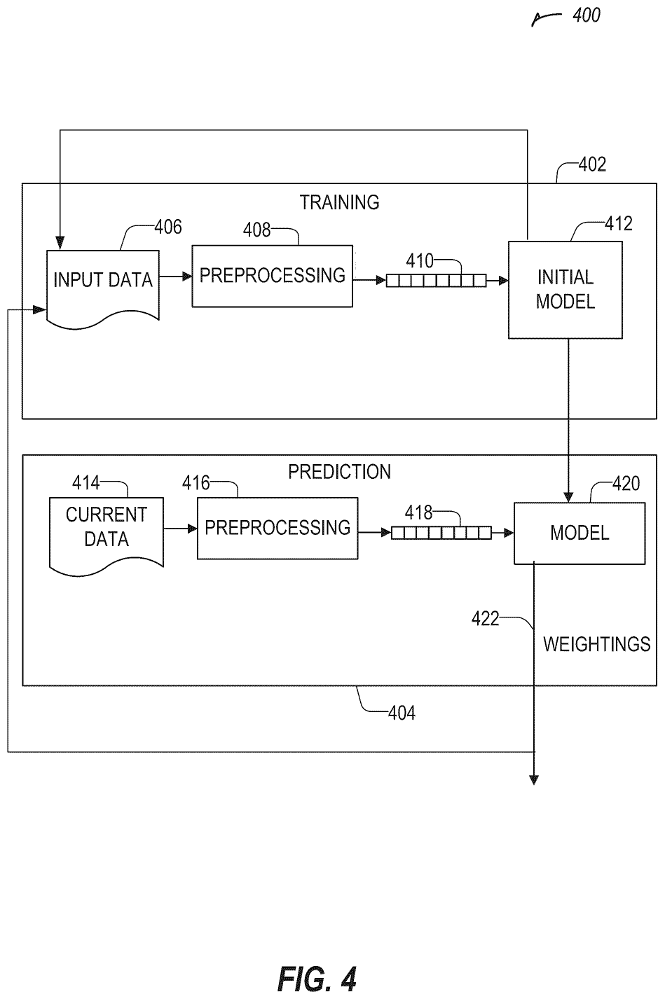

FIG. 4 illustrates a machine learning engine for training and execution related to making a financing decision by an autonomous decision bot, according to various examples. The machine learning engine may be deployed to execute at a mobile device (e.g., a cell phone, a tablet, etc.) or a computer (e.g., a desktop, a laptop, etc.). FIG. 4 shows an example machine learning engine 400 according to some examples of the present disclosure.

Machine learning engine 400 uses a training engine 402 and a prediction engine 404. Training engine 402 uses input data 406, for example after undergoing preprocessing component 408, to determine one or more features 410. The one or more features 410 may be used to generate an initial model 412, which may be updated iteratively or with future labeled or unlabeled data (e.g., during reinforcement learning), for example to improve the performance of the prediction engine 404 or the initial model 412. An improved model may be redeployed for use.

The input data 406 may include financial information, business operation data, or personal information, such as annual income, employee status, credit history including credit scores or reports, existing debts (e.g., a loan, a credit card balance, or other liabilities), bank statements reflecting account balances or cash flow, tax returns for recent years, debt-to-income ratio, assets documentation (e.g., property ownership, investments, savings accounts, etc.), corporate or business structure (e.g., partnership, number of silent partners, limited liability company (LLC), etc.), type of business (e.g., a risk level for a business operation), competitor data, state of an industry data, credit availability, historical revenue or profit, location of business assets, liabilities, or employees, reviews of the business, or the like.

In the prediction engine 404, current data 414 (e.g., information from a client system, such as via an API, which may include transaction histories, balance sheets, income statements, etc.) may be input to preprocessing component 416. In some examples, preprocessing component 416 and preprocessing component 408 are the same. The prediction engine 404 produces feature vector 418 from the preprocessed current data, which is input into the model 420 to generate one or more criteria weightings 422. The criteria weightings 422 may be used to output a prediction, as discussed further below.

The training engine 402 may operate in an offline manner to train the model 420 (e.g., on a server). The prediction engine 404 may be designed to operate in an online manner (e.g., in real-time, at a mobile device, on a wearable device, etc.). In some examples, the model 420 may be periodically updated via additional training (e.g., via updated input data 406 or based on labeled or unlabeled data output in the weightings 422) or based on identified future data, such as by using reinforcement learning to personalize a general model (e.g., the initial model 412) to a particular user.

Labels for the input data 406 may include a decision outcome, such as “loan approved” or “loan denied,” a numerical rating indicating a potential customer's creditworthiness, a risk level for a customer, a decision outcome such as “requires more input data,” an ultimate financial decision (e.g., a financial decision to decline a requested loan, which may conflict with a decision by an autonomous bot, which may also be included in the label), or the like.

The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 402 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example embodiment, a regression model is used and the model 420 is a vector of coefficients corresponding to a learned importance for each of the features in the vector of features 410, 418. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like. Once trained, the model 420 may output a prediction, such as a financing decision based on input client data. This decision may be based on the weightings developed during the training 402, which allows the model to make a decision (e.g., assess loan eligibility or risk) based on client data. The model 420 may update a decision when new client data is provided or based on retraining of the model 420 (e.g., based on a changed financial landscape, such as a change to interest rates or financial situation of a lending financial institution).

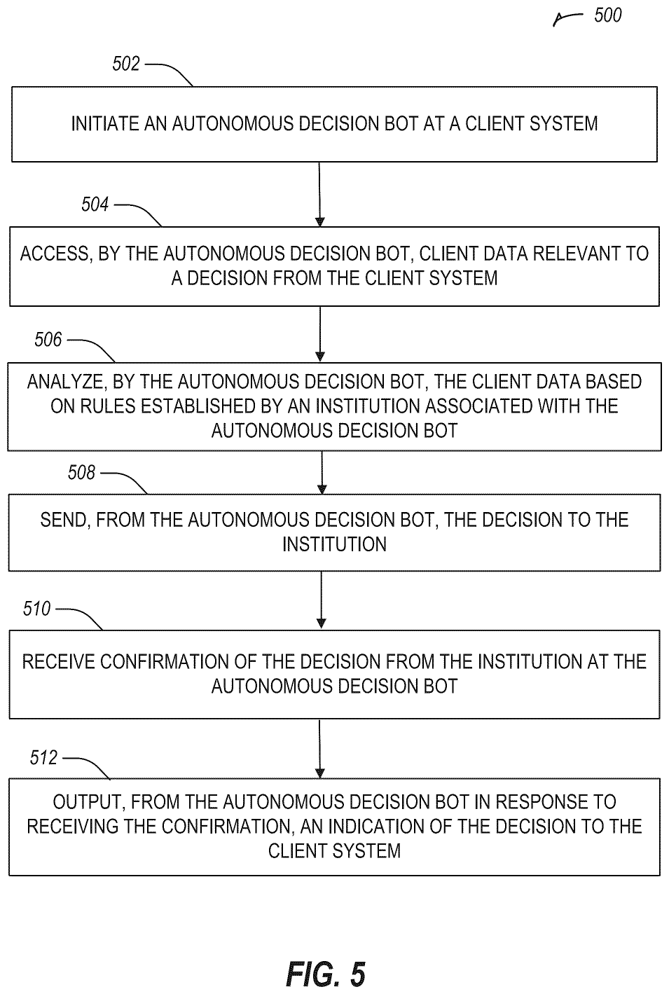

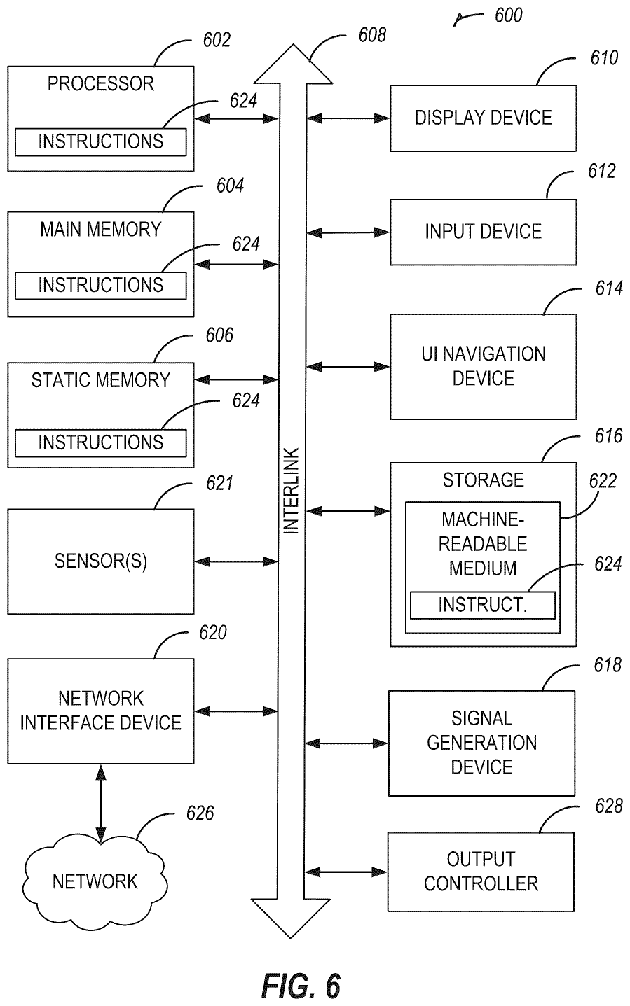

FIG. 5 illustrates a flowchart showing a technique 500 for ensuring data privacy during an autonomous bot decision, according to various examples. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 6.

The technique 500 includes an operation 502 to initiate an autonomous decision bot at a client system. The initiation of the autonomous decision bot at a client system may begin with the client downloading or receiving the bot from the financial institution. In some examples, the bot may be configured by setting connection parameters and granting necessary permissions to allow the bot to access specific parts of the client system, such as an ERP system. In other examples, the bot may operate within certain regulatory requirements applicable to the industry or location associated with the client system.

The technique 500 includes an operation 504 to access, by the autonomous decision bot, client data relevant to a financing decision from the client system. Examples of client data that may be accessed by the autonomous decision bot includes detailed financial statements, such as balance sheets or income statements, transaction histories, credit reports, records of assets or liabilities, or the like. In some examples, the autonomous decision bot may retrieve dynamic data such as cash flow statements or real-time inventory levels, for example using an API call or SQL query. In some examples, the accessed client data is temporarily storied in a secure cache or memory allotted to the autonomous decision bot for processing.

The technique 500 includes an operation 506 to analyze, by the autonomous decision bot, the client data based on rules established by an institution associated with the autonomous decision bot. The rules may include financial rules, and the institution may be a financial institution. An example of a rule that may be used in the decision by the autonomous decision bot includes evaluating a debt-to-income ratio, where a lower ratio may indicate a higher financial health score or be associated with a lower risk profile for the decision. Other examples include analyzing payment history to identify patterns of late payments or defaults, which may signal higher risk, assessing liquidity ratios to evaluate how well the customer may meet short-term obligations without selling inventory, or the like. In an example, the rules may include at least one of a credit score threshold, a debt-to-income ratio, a liquidity ratio, historical payment behavior (e.g., a minimum or maximum number of actions, such as on time payments or defaults, a percentage of early payments, etc.), or the like.

The technique 500 includes an operation 508 to send, from the autonomous decision bot, the decision to the institution. The autonomous decision bot may communicate a financing decision to a financial institution without transmitting the client data. In some examples, the autonomous decision bot may use encrypted messaging or secure data transmission services such as HTTPS or a VPN channel to transmit the financing decision to the financial institution. The financing decision may include the decision (e.g., approved or denied), a risk score based on the analyzed client data, a recommendation for terms or conditions, or the like. Operation 508 may include sending at least one key financial metric or ratio used by the autonomous decision bot in the financing decision.

The technique 500 includes an operation 510 to receive confirmation of the decision from the institution at the autonomous decision bot. The confirmation may include a final determination for the decision. For example, the autonomous decision bot may recommend an approval of the request, but the institution may deny the request based on other qualitative factors or other factors (e.g., a change in interest rate, a change in regulations, a change in circumstances at the institution, or the like). In some examples, the confirmation may be delivered through a secure communication channel. In some examples, the institution may use a security measure including a digital signature or a Hash-Based Message Authentication Codes (HMACs) to authenticate the confirmation. In an example, operation 510 includes receiving a verification response from the financial institution. In this example, operation 510 may include outputting the indication in response to determining that the verification response matches a verification code or checksum generated at the autonomous decision bot.

The technique 500 includes an operation 512 to output, from the autonomous decision bot in response to receiving the confirmation, an indication of the decision to the client system. The autonomous decision bot may communicate the decision to the client system via an API or local communication, in some examples. In some examples, the institution may send the decision to the client system (e.g., with or without sending to the autonomous decision bot).

The technique 500 may include an operation to output, from the autonomous decision bot, a request for additional information in response to a determination that the client data is insufficient to make the decision. The technique 500 may include an operation to provide, from the autonomous decision bot, a unique token to an agent at the institution, the unique token indicating to the agent to initiate a release of funds based on the decision. The technique 500 may include an operation to, in response to outputting the indication of the decision to the client system, execute a self-destruction protocol at the autonomous decision bot, the self-destruction protocol including erasing all executable components of the autonomous decision bot from the client system, and delete any temporary data stored by the autonomous decision bot during operation. The technique 500 may include an operation to adjust, at the autonomous decision bot, the rules dynamically based on data received from the institution.

FIG. 6 illustrates generally an example of a block diagram of a machine upon which any one or more of the techniques discussed herein may perform, according to various examples. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: receiving, by a server at a financial institution, a financing decision from an autonomous decision bot deployed within a customer's financial system, wherein the financing decision is based on an analysis of a customer's financial data according to financing criteria; validating the received financing decision; updating a customer account associated with the financing decision in a financial institution's records to reflect the financing decision; and generating a transaction record for the financing decision.

In Example 2, the subject matter of Example 1 includes, sending a notification to the client system confirming the updated status of the financing decision.

In Example 3, the subject matter of Examples 1-2 includes, encrypting the financing decision before transmitting the financing decision from the autonomous bot to the financial institution.

In Example 4, the subject matter of Examples 1-3 includes, verifying the authenticity of the autonomous decision bot using at least one of digital certificates and public key infrastructure.

In Example 5, the subject matter of Examples 1-4 includes, storing the generated transaction record on a blockchain ledger.

Example 6 is a system comprising: processing circuitry configured to manage operations of an autonomous decision bot within a client system, wherein the processing circuitry is further configured to: obtain the autonomous decision bot at the client system; access financial data relevant to a financing decision from the client system; analyze the accessed financial data based on predefined financing rules established by a financial institution associated with the client system to determine a financing decision; facilitate communication of the financing decision to the financial institution without transmitting the accessed financial data to the financial institution; receive a confirmation from the financial institution acknowledging receipt of the financing decision; and in response to receiving the confirmation, execute a self-destruction protocol.

In Example 7, the subject matter of Example 6 includes, conducting a data integrity check before analyzing the financial data.

In Example 8, the subject matter of Examples 6-7 includes, encrypting the communication between the autonomous decision bot and the financial institution.

In Example 9, the subject matter of Example 6-8 includes, dynamically adjusting the predefined financing rules based on at least one outcome and trend observed in prior financing decisions.

In Example 10, the subject matter of Examples 6-9 includes, in response to outputting the indication of the financing decision to the client system, executing a self-destruction protocol at the autonomous decision bot, the self-destruction protocol including erasing all executable components of the autonomous decision bot from the client system, and deleting any temporary data stored by the autonomous decision bot during operation.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
initiating an autonomous decision bot at a client system;
accessing, by the autonomous decision bot, client data relevant to a financing decision from the client system;
analyzing, by the autonomous decision bot, the client data based on financing rules established by a financial institution associated with the autonomous decision bot to determine the financing decision;
sending, from the autonomous decision bot, the financing decision to the financial institution without transmitting the client data to the financial institution;
receiving confirmation of the financing decision from the financial institution at the autonomous decision bot; and
outputting, from the autonomous decision bot in response to receiving the confirmation, an indication of the financing decision to the client system.

2. The method of claim 1, further comprising outputting, from the autonomous decision bot, a request for additional information in response to a determination that the client data is insufficient to make the financing decision.

3. The method of claim 1, wherein receiving the confirmation includes receiving a verification response from the financial institution; and wherein outputting the indication includes outputting the indication in response to determining that the verification response matches a verification code or checksum generated at the autonomous decision bot.

4. The method of claim 1, further comprising providing, from the autonomous decision bot, a unique token to an agent at the financial institution, the unique token indicating to the agent to initiate a release of funds based on the financing decision.

5. The method of claim 1, further comprising, in response to outputting the indication of the financing decision to the client system, executing a self-destruction protocol at the autonomous decision bot, the self-destruction protocol including erasing all executable components of the autonomous decision bot from the client system, and deleting any temporary data stored by the autonomous decision bot during operation.

6. The method of claim 1, wherein the financing rules include at least one of a credit score threshold, a debt-to-income ratio, a liquidity ratio, or a historical payment behavior.

7. The method of claim 1, further comprising adjusting, at the autonomous decision bot, the financing rules dynamically based on data received from the financial institution.

8. The method of claim 1, wherein sending the financing decision to the financial institution includes sending at least one key financial metric or ratio used by the autonomous decision bot in the financing decision.

9. At least one non-transitory machine-readable medium including instructions that, when executed by processing circuitry, cause the processing circuitry to perform operations to:
initiate an autonomous decision bot at a client system;
access, by the autonomous decision bot, client data relevant to a financing decision from the client system;
analyze, autonomous decision bot, the client data based on financing rules established by a financial institution associated with the autonomous decision bot to determine the financing decision;
send, from the autonomous decision bot, the financing decision to the financial institution without transmitting the client data to the financial institution;
receive a confirmation of the financing decision from the financial institution at the autonomous decision bot; and
output, from the autonomous decision bot in response to receiving the confirmation, an indication of the financing decision to the client system.

10. The at least one non-transitory machine-readable medium of claim 9, wherein the financing rules include at least one of a credit score threshold, a debt-to-income ratio, a liquidity ratio, or a historical payment behavior.

11. The at least one non-transitory machine-readable medium of claim 9, further comprising operations to output, from the autonomous decision bot, a request for additional information in response to a determination that the client data is insufficient to make the financing decision.

12. The at least one non-transitory machine-readable medium of claim 9, further comprising operations to, in response to outputting the indication of the financing decision to the client system, execute a self-destruction protocol at the autonomous decision bot, the self-destruction protocol including erasing all executable components of the autonomous decision bot from the client system, and delete any temporary data stored by the autonomous decision bot during operation.

13. The at least one non-transitory machine-readable medium of claim 9, further comprising operations to provide, from the autonomous decision bot, a unique token to an agent at the financial institution, the unique token indicating to the agent to initiate a release of funds based on the financing decision.

14. A system comprising:
processing circuitry; and
memory including instructions, which when executed by the processing circuitry cause the processing circuitry to perform operations to:
initiate an autonomous decision bot at a client system;
access, by the autonomous decision bot, client data relevant to a financing decision from the client system;
analyze, by the autonomous decision bot, the client data based on financing rules established by a financial institution associated with the client system to determine the financing decision;
send, from the autonomous decision bot, the financing decision to the financial institution without transmitting the client data to the financial institution;
receive a confirmation of the financing decision from the financial institution at the autonomous decision bot; and
output, from the autonomous decision bot in response to receiving the confirmation, an indication of the financing decision to the client system.

15. The system of claim 14, wherein the financing rules include at least one of a credit score threshold, a debt-to-income ratio, a liquidity ratio, or a historical payment behavior.

16. The system of claim 14, further comprising operations to output, from the autonomous decision bot, a request for additional information in response to a determination that the client data is insufficient to make the financing decision.

17. The system of claim 14, wherein the autonomous decision bot dynamically adjusts the financing rules based on data received from the financial institution.

18. The system of claim 14, wherein to send the financing decision to the financial institution, the operations further include operations to send at least one key financial metric or ratio used in making the financing decision.

19. The system of claim 14, further comprising operations to, in response to outputting the indication of the financing decision to the client system, execute a self-destruction protocol at the autonomous decision bot, the self-destruction protocol including erasing all executable components of the autonomous decision bot from the client system, and delete any temporary data stored by the autonomous decision bot during operation.

20. The system of claim 14, further comprising operations to provide, from the autonomous decision bot, a unique token to an agent at the financial institution, the unique token indicating to the agent to initiate a release of funds based on the financing decision.
